(19) United States
(12) Patent Application Publication
(10) Pub. No.: US 2026/0021775 A1
(43) Pub. Date: Jan. 22, 2026

(54) SOUND APPARATUS AND CHAIR, VEHICULAR SEAT, AND VEHICULAR APPARATUS EACH INCLUDING THE SOUND APPARATUS

(71) Applicant: LG Display Co., Ltd., Seoul (KR)

(72) Inventors: DoHyeong KIM, Paju-si (KR); MinKyu CHOI, Paju-si (KR)

(73) Assignee: LG Display Co., Ltd., Seoul (KR)

(21) Appl. No.: 19/095,973

(22) Filed: Mar. 31, 2025

(30) Foreign Application Priority Data
Jul. 17, 2024 (KR) 10-2024-0094293

(51) Int. Cl. B60R 11/02; H04R 5/02

(52) U.S. Cl. CPC B60R 11/0217; H04R 5/023; H04R 2499/13

(57) ABSTRACT

A sound apparatus can include an enclosure including an internal space, a vibration member connected to the enclosure and overlapping with the internal space of the enclosure, and a vibration device connected to the vibration member and configured to vibrate the vibration member. Also, the sound apparatus can further include a guide protrusion portion protruding from the enclosure to surround an edge of the vibration member.

### CROSS-REFERENCE TO RELATED APPLICATIONS

This application claims the benefit of and priority to Korean Patent Application No. 10-2024-0094293 filed in the Republic of Korea on Jul. 17, 2024, the entirety of which is incorporated herein by reference for all purposes.

### BACKGROUND

### Technical Field

The present disclosure relates to a sound apparatus and a chair, a vehicular seat, and a vehicular apparatus each including the sound apparatus.

### Description of the Related Art

Vehicles can include a sound apparatus which outputs a sound, based on an audio signal output from a multimedia device such as a car audio. The sound apparatus can vibrate based on a coil type including a magnet and a coil or a piezoelectric type including a piezoelectric device. For example, the sound apparatus applied to vehicles can include a front speaker and a rear speaker.

As various technologies associated with vehicles advance, a demand level of passengers in vehicles is increasing, and research on technology for implementing an independent sound field or a stereophonic sound in vehicles is being done.

Sound apparatuses of vehicles have a limitation in outputting an independent sound field or a stereophonic sound through a front speaker and a rear speaker. When the number of speakers increases, sound apparatuses of vehicles can output a stereophonic sound, but have a limitation in increasing the number of speakers due to an internal space limitation of vehicles and sizes of speakers based on the coil type. Also, in speakers based on the piezoelectric type, there is a problem where it is difficult to provide an independent sound field in space-limited vehicles due to a wide orientation when outputting a sound. Further, there exists a need for a sound apparatus that can provide individual personalized and directional sound with high quality to a user, even in situations where space is limited, which can have improved quality in the mid-high frequency range.

### SUMMARY OF THE DISCLOSURE

The inventors have recognized the problems described above and have performed various research and experiments, which can enhance a sound characteristic and/or a sound pressure level characteristic of a vehicular sound apparatus and can implement an independent sound field in a vehicle. Based on the various research and experiments, the inventors have invented a sound apparatus and a chair, a vehicular seat, and a vehicular apparatus each including the sound apparatus, which can enhance a sound characteristic and/or a sound pressure level characteristic of a vehicular sound apparatus and can implement an independent sound field in a vehicle.

One or more embodiments of the present disclosure can provide a sound apparatus and a chair, a vehicular seat, and a vehicular apparatus each including the sound apparatus, which can enhance a sound characteristic and/or a sound pressure level characteristic.

One or more embodiments of the present disclosure can provide a sound apparatus and a chair, a vehicular seat, and a vehicular apparatus each including the sound apparatus, which can enhance a sound characteristic and/or a sound pressure level characteristic of a middle-high pitched sound band.

One or more embodiments of the present disclosure can provide a sound apparatus and a chair, a vehicular seat, and a vehicular apparatus each including the sound apparatus, which can enhance a sound characteristic and/or a sound pressure level characteristic of the middle-high pitched sound band and can have a narrow orientation in the middle-high pitched sound band.

One or more embodiments of the present disclosure can provide a sound apparatus and a chair, a vehicular seat, and a vehicular apparatus each including the sound apparatus, which can implement an independent sound field and/or a stereophonic sound.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description and claims hereof as well as the appended drawings.

A sound apparatus according to one or more embodiment of the present disclosure can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

A chair according to one or more embodiment of the present disclosure can include a seat part, a backrest part connected to the seat part, and at least one sound generating apparatus disposed on the backrest part and configured to output a sound toward a front surface of the backrest part. The at least one sound generating apparatus can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

A vehicular seat according to one or more embodiment of the present disclosure can include a seat cushion, a seat back connected to the seat cushion, and at least one sound generating apparatus disposed on the seat back and configured to output a sound toward a front surface of the seat back. The at least one sound generating apparatus can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

A vehicular apparatus according to one or more embodiment of the present disclosure can a vehicular seat. The vehicular seat can include a seat cushion, a seat back connected to the seat cushion, and at least one sound generating apparatus disposed on the seat back and configured to output a sound toward a front surface of the seat back. The at least one sound generating apparatus can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

According to one or more embodiments of the present disclosure, a sound apparatus and a chair, a vehicular seat, and a vehicular apparatus each including the sound apparatus, which can enhance a sound characteristic and/or a sound pressure level characteristic, can be provided.

According to one or more embodiments of the present disclosure, a sound apparatus and a chair, a vehicular seat, and a vehicular apparatus each including the sound apparatus, which can enhance a sound characteristic and/or a sound pressure level characteristic of a middle-high pitched sound band, can be provided.

According to one or more embodiments of the present disclosure, a sound apparatus and a chair, a vehicular seat, and a vehicular apparatus each including the sound apparatus, which can enhance a sound characteristic and/or a sound pressure level characteristic of the middle-high pitched sound band and can have a narrow orientation in the middle-high pitched sound band, can be provided.

According to one or more embodiments of the present disclosure, a sound apparatus and a chair, a vehicular seat, and a vehicular apparatus each including the sound apparatus, which can implement an independent sound field and/or a stereophonic sound, can be provided.

According to one or more embodiments of the present disclosure, a piezoelectric device which is lightweight and is low in power consumption can be used, and a sound characteristic and/or a sound pressure level characteristic of the middle-high pitched sound band can be enhanced, thereby providing a sound apparatus and a chair, a vehicular seat, and a vehicular apparatus each including the sound apparatus, which can implement low power and can be lightweight.

According to one or more embodiments of the present disclosure, a sound apparatus and a chair, a vehicular seat, and a vehicular apparatus each including the sound apparatus can implement an independent sound field and/or a stereophonic sound by using a small number of speakers, thereby realizing an effect of uni-materialization.

The effects of the present disclosure are not limited to the aforesaid, but other effects not described herein will be clearly understood by those skilled in the art from the following descriptions.

The details of the present disclosure described in technical problem, technical solution, and advantageous effects do not specify essential features of claims, and thus, the scope of claims is not limited by the details described in detailed description of the invention.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure, and together with the description serve to explain the principles and examples of the disclosure.

FIG. 1 is a diagram illustrating a sound apparatus according to an embodiment of the present disclosure.

FIG. 2 is an exploded perspective view of the sound apparatus illustrated in FIG. 1 according to an embodiment of the present disclosure.

FIG. 3 is a cross-sectional view taken along line I-I′ illustrated in FIG. 1 according to an embodiment of the present disclosure.

FIG. 4 is a diagram illustrating a sound apparatus according to another embodiment of the present disclosure.

FIG. 5 is an exploded perspective view of the sound apparatus illustrated in FIG. 4 according to another embodiment of the present disclosure.

FIG. 6 is a cross-sectional view taken along line II-II′ illustrated in FIG. 4 according to another embodiment of the present disclosure.

FIG. 7 is another cross-sectional view taken along line II-II′ illustrated in FIG. 4 according to another embodiment of the present disclosure.

FIG. 8 is a diagram illustrating a vibration device according to an embodiment of the present disclosure.

FIG. 9 is a cross-sectional view taken along line III-III′ illustrated in FIG. 8 according to an embodiment of the present disclosure.

FIG. 10 is a cross-sectional view taken along line IV-IV′ illustrated in FIG. 8 according to an embodiment of the present disclosure.

FIG. 11 is a diagram illustrating a vibration part according to another embodiment of the present disclosure.

FIG. 12 is a diagram illustrating a vibration part according to another embodiment of the present disclosure.

FIG. 13 is a diagram illustrating a vibration device according to another embodiment of the present disclosure.

FIG. 14 is a diagram illustrating a chair according to an embodiment of the present disclosure.

FIG. 15 is a diagram illustrating a vehicular seat according to an embodiment of the present disclosure.

FIG. 16 is a diagram illustrating a vehicular apparatus according to an embodiment of the present disclosure.

FIG. 17 is a diagram illustrating sound output characteristics of sound apparatuses according to an embodiment of the present disclosure and an experiment example.

Throughout the drawings and the detailed description, unless otherwise described, the same drawing reference numerals should be understood to refer to the same elements, features, and structures. The sizes, lengths, and thicknesses of layers, regions and elements, and depiction of thereof can be exaggerated for clarity, illustration, and/or convenience.

### DETAILED DESCRIPTION OF THE EMBODIMENTS

Advantages and features of the present disclosure, and implementation methods thereof, are clarified through the embodiments described with reference to the accompanying drawings. The present disclosure can, however, be embodied in different forms and should not be construed as limited to the embodiments set forth herein. Rather, these embodiments are examples and are provided so that this disclosure can be thorough and complete, to assist those skilled in the art to understand the inventive concepts without limiting the protected scope of the present disclosure.

Shapes (e.g., sizes, lengths, widths, heights, thicknesses, locations, radii, diameters, and areas), sizes, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements can be added unless a term such as “only” or the like is used. The terms used in the present disclosure are merely used in order to describe example embodiments, and are not intended to limit the scope of the present disclosure. The terms of a singular form can include plural forms unless the context clearly indicates otherwise.

In construing an element, the element is construed as including an error region although there is no explicit description thereof.

In describing a positional relationship, for example, when the positional order is described as “on,” “above,” “below,” “beneath,” and “next,” the situation of no contact therebetween can be included, unless “just” or “direct” is used.

If it is mentioned that a first element is positioned “on” a second element, it does not mean that the first element is essentially positioned above the second element in the figure. The upper part and the lower part of an object concerned can be changed depending on the orientation of the object. Consequently, the situation in which a first element is positioned “on” a second element includes the situation in which the first element is positioned “below” the second element as well as the situation in which the first element is positioned “above” the second element in the figure or in an actual configuration.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms. These terms are only used to distinguish one element from another. For example, a first element could be termed a second element, and, similarly, a second element could be termed a first element.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element is “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The term “at least one” should be understood as including any and all combinations of one or more of the associated listed items. For example, “at least one among a first element, a second element and a third element” can include all combinations of two or more elements selected from the first, second and third elements as well as each element of the first, second and third elements. Further, the term “can” fully encompasses all the meanings and coverages of the term “may” and vice versa.

Features of various embodiments of the present disclosure can be partially or entirety coupled to or combined with each other, can be technically associated with each other, and can be variously inter-operated, linked or driven together. The embodiments of the present disclosure can be implemented or carried out independently of each other, or can be implemented or carried out together in a co-dependent or related relationship. In one or more aspects, the components of each apparatus according to various embodiments of the present disclosure are operatively coupled and configured.

In the following description, various example embodiments of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements can be denoted by the same reference numerals even though they are depicted in different drawings. In addition, for convenience of description, a scale, dimension, size, and thickness of each of the elements illustrated in the accompanying drawings can be different from an actual scale, dimension, size, and thickness, and thus, embodiments of the present disclosure are not limited to a scale, dimension, size, and thickness illustrated in the drawings.

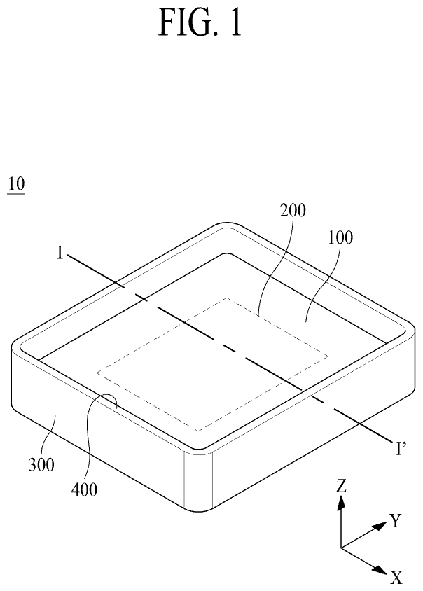

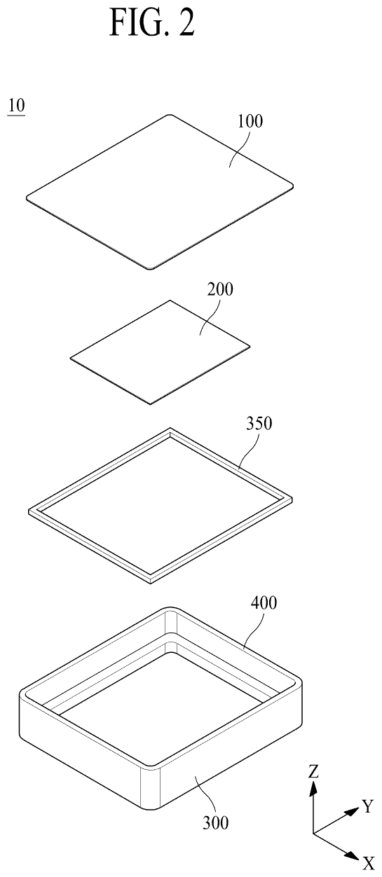

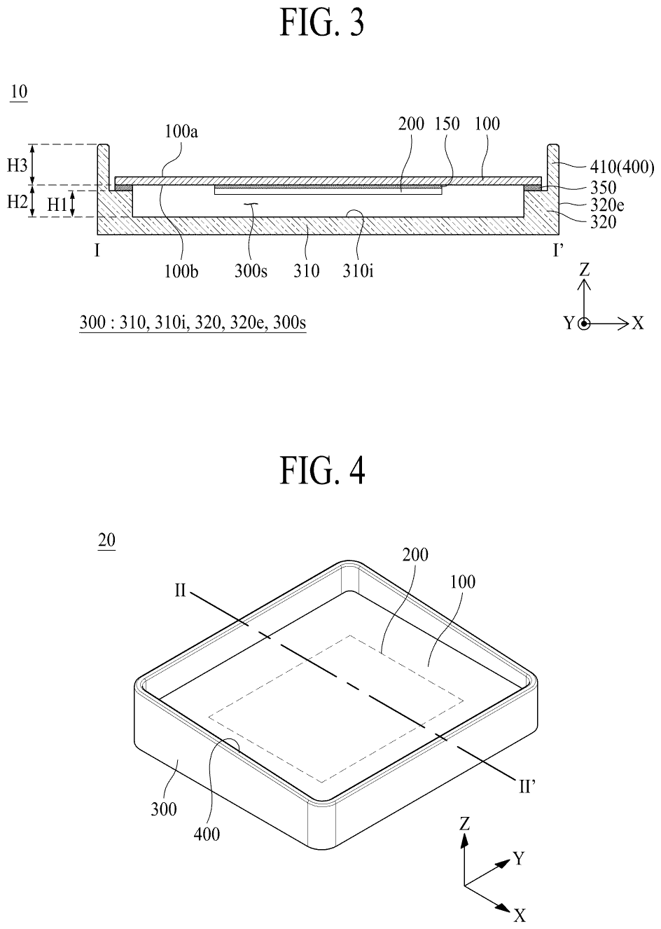

FIG. 1 is a diagram illustrating a sound apparatus 10 according to one or more embodiments of the present disclosure. FIG. 2 is an exploded perspective view of the sound apparatus 10 illustrated in FIG. 1 according to an embodiment of the present disclosure. FIG. 3 is a cross-sectional view taken along line I-I′illustrated in FIG. 1 according to an embodiment of the present disclosure.

Referring to FIGS. 1 to 3, a sound apparatus 10 according to an embodiment of the present disclosure can be configured to output a sound. For example, the sound apparatus 10 can be a sound output apparatus, a sound generating apparatus, a speaker, a speaker apparatus, a sound apparatus for chair, a sound output apparatus for chair, a sound generating apparatus for chair, a speaker for chair, a speaker apparatus for chair, a sound apparatus for vehicular seat, a sound output apparatus for vehicular seat, a sound generating apparatus for vehicular seat, a speaker for vehicular seat, or a speaker apparatus for vehicular seat, but embodiments of the present disclosure are not limited thereto. For example, the vehicular apparatus can include a vehicle, a train, a ship, or an aircraft, but embodiments of the present disclosure are not limited thereto.

The sound apparatus 10 according to an embodiment of the present disclosure can include a vibration member 100, a vibration device 200, an enclosure 300, and a guide protrusion portion 400.

The vibration member 100 can output a sound (or a sound wave), based on a vibration (or displacement) of the vibration device 200. The vibration member 100 can be a diagram, a vibration plate, a vibration substrate, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 100 can include a single nonmetal material or a complex nonmetal material, but embodiments of the present disclosure are not limited thereto. For example, the single nonmetal material or the complex nonmetal material of the vibration member 100 can include one or more materials of wood, rubber, plastic, carbon, glass, fiber, cloth, paper, mirror, and leather, but embodiments of the present disclosure are not limited thereto. For example, the paper can be cone paper for speaker. For example, the cone paper can be pulp or foam plastic, but embodiments of the present disclosure are not limited thereto.

The vibration member 100 according to an embodiment of the present disclosure can include a plastic material or a plastic material of a styrene material, but embodiments of the present disclosure are not limited thereto. For example, the plastic material of the vibration member 100 can include polyethylene terephthalate, polycarbonate, polyimide, polyimide, polypropylene, polyarylate, polyethersulfone, polyethylene naphthalate, polysulfone, cyclo-olefin copolymer, or carbon fiber reinforced plastic (CFRP), but embodiments of the present disclosure are not limited thereto. For example, the styrene material of the vibration member 100 can be an ABS material. The ABS material can be acrylonitrile, butadiene, and styrene, but embodiments of the present disclosure are not limited thereto.

According to another embodiment of the present disclosure, the vibration member 100 can include a porous material. For example, the vibration member 100 can include a micro cellular plastic material. For example, the vibration member 100 can include a polyethylene terephthalate material or a polycarbonate material, but embodiments of the present disclosure are not limited thereto. For example, the vibration member 100 can include a micro cellular polyethylene terephthalate (PET) (MCPET) material. The vibration member 100 including MCPET can be low in density, good in elastic force, and high in sound source reproduction capability, and thus, can enhance the quality of a sound.

The vibration member 100 can have a polygonal shape including a rectangular shape or a square shape, a round polygonal shape including a curve shape (or a round shape or rounded corners), a circular shape, or an oval shape, but embodiments of the present disclosure are not limited thereto.

The vibration member 100 can include a structure which has an entirely uniform thickness. For example, the vibration member 100 can include a plate structure which has an entirely uniform thickness, but embodiments of the present disclosure are not limited thereto. For example, the vibration member 100 can include a non-planar structure including a convex portion and/or a concave portion.

The vibration member 100 can include a first surface 100a (or a front surface) or a second surface 100b (or a rear surface) opposite to (or differing from) the first surface 100a. For example, the first surface 100a of the vibration member 100 can be a front surface or an upper surface in a direction (or a forward direction or an upper vertical direction) facing air, and the second surface 100b of the vibration member 100 can be a rear surface, a backside surface, or a lower surface in a direction (or a rearward direction or a lower vertical direction) facing the enclosure 300, but embodiments of the present disclosure are not limited thereto.

The vibration device 200 can be configured to vibrate the vibration member 100. The vibration device 200 can be connected to or configured in the vibration member 100. The vibration device 200 can be connected to or configured in at least one surface of the vibration member 100. The vibration device 200 can be disposed or configured in an internal space 300s of the enclosure 300 to vibrate (or displace or drive) the vibration member 100. For example, the vibration device 200 can be connected to or configured in the second surface 100b (or a rear surface) of the vibration member 100, but embodiments of the present disclosure are not limited thereto.

The vibration device 200 can vibrate (or displace or drive) to vibrate (or displace or drive) the vibration member 100, based on a driving signal (or a vibration driving signal or a voice signal) applied from a driving circuit. For example, the vibration device 200 can output a sound by using the vibration member 200 as a vibration plate. The vibration device 200 can include a piezoelectric material. For example, the vibration device 200 can be a piezoelectric-type vibration apparatus including a piezoelectric material. For example, the vibration device 200 can be a vibration generating device, a vibration film, a vibration generating film, a vibration generator, a vibrator, an active vibrator, an active vibration generator, an actuator, an exciter, a film actuator, a film exciter, an ultrasound actuator, or an active vibration member, but embodiments of the present disclosure are not limited thereto.

The vibration device 200 can have a polygonal shape including a rectangular shape or a square shape, a round polygonal shape including a curve shape (or a round shape or rounded corners), a circular shape, or an oval shape, but embodiments of the present disclosure are not limited thereto. The vibration device 200 can have a shape which corresponds to or is equal to that of the vibration member 100, but embodiments of the present disclosure are not limited thereto. For example, the vibration device 200 can have the same shape as that of the vibration member 100. The vibration device 200 can be configured to have a shape which is equal to or different from that of the vibration member 100 and have a size which is less than that of the vibration member 100, but embodiments of the present disclosure are not limited thereto.

The sound apparatus 10 according to an embodiment of the present disclosure can further include a connection member 150 (e.g., see FIG. 3).

The connection member 150 can be disposed or configured between the vibration device 200 and the vibration member 100. The connection member 150 can be disposed between the vibration device 200 and the vibration member 100 and can connect or couple the vibration device 200 to the vibration member 100. For example, the vibration device 200 can be connected or coupled to the vibration member 100 by using the connection member 150. For example, the vibration device 200 can be connected to or supported by the second surface 100b (or the rear surface) of the vibration member 100 by using the connection member 150, but embodiments of the present disclosure are not limited thereto. For example, the connection member 150 can be a first connection member, an adhesive member, or a first adhesive member, but embodiments of the present disclosure are not limited thereto.

The connection member 150 according to an embodiment of the present disclosure can include an adhesive layer which is good in sticky force or adhesive force. For example, the connection member 150 can include a material including an adhesive layer which is good in sticky force or adhesive force, with respect to each of the second surface 100b of the vibration member 100 and the vibration device 200. For example, the connection member 150 can include a foam pad, a double-sided tape, a double-sided foam pad, a double-sided foam tape, an adhesive, a double-sided adhesive, a double-sided foam adhesive, a double-sided foam adhesive, or an adhesive sheet, but embodiments of the present disclosure are not limited thereto. For example, when the connection member 150 includes an adhesive sheet (or an adhesive layer), the connection member 150 can include only an adhesive layer or a tacky layer without a base member such as a plastic material.

The adhesive layer of the connection member 150 according to an embodiment of the present disclosure can include an adhesive material such as pressure sensitive adhesive (PSA), optically cleared adhesive (OCA), optically cleared resin (OCR), epoxy resin, acrylic resin, silicone resin, or urethane resin, but embodiments of the present disclosure are not limited thereto. For example, the adhesive layer of the connection member 150 can include an acrylic material (or substance) having a characteristic where an adhesive force is relatively good and hardness is high. Accordingly, the transfer efficiency of a vibration force (or a displacement force) transferred from the vibration device 200 to the vibration member 100 can increase.

According to another embodiment of the present disclosure, the adhesive layer of the connection member 150 can further include an additive such as a tackifier, a wax component, or an antioxidant. The additive can prevent the connection member 150 from being detached (or striped) from the vibration member 100 by a vibration of the vibration device 200. For example, the tackifier can be rosin derivatives, and the wax component can be a paraffin wax, but embodiments of the present disclosure are not limited thereto. For example, the antioxidant can be a phenolic antioxidant such as thioester, but embodiments of the present disclosure are not limited thereto.

According to another embodiment, the connection member 150 can further include a hollow portion provided between the vibration member 100 and the vibration device 200. For example, the connection member 150 can be provided along an edge of the vibration device 200, but embodiments are not limited thereto. The hollow portion of the connection member 150 can provide an air gap between the vibration member 100 and the vibration device 200. The air gap can allow a sound wave (or a sound pressure level) based on a vibration of the vibration device 200 to concentrate on the vibration member 100 without being dispersed by the connection member 150, and thus, the loss of a vibration by the connection member 150 can be minimized, thereby increasing a sound characteristic and/or a sound pressure level characteristic of a sound generated based on a vibration of the vibration member 100.

The enclosure 300 can be disposed or configured on the second surface 100b (or the rear surface) of the vibration member 100. The enclosure 300 can include an internal space 300s. The enclosure 300 can be covered or overlapped by the vibration member 100 and can be configured so that the internal space 300s is provided in the second surface 100b (or the rear surface) of the vibration member 100. For example, the internal space 300s of the enclosure 300 can be surrounded by the second surface 100b (or the rear surface) of the vibration member 100 and an inner surface 310i of the enclosure 300. For example, the enclosure 300 can include a box shape where one side (or an upper side) thereof is opened, to provide (or configure) the internal space 300s. The box shape of the enclosure 300 can include a round polygonal shape including a curved portion or a tetragonal shape, but embodiments of the present disclosure are not limited thereto. For example, the enclosure 300 can be a housing, a case, an external case, a case member, a housing member, a cabinet, a sealing member, a scaling cap, a scaling box, or a sound box, but embodiments of the present disclosure are not limited thereto. For example, the internal space 300s of the enclosure 300 can be an accommodating space, a storage space, a gap space, an air space, a vibration space, a sound space, a sounding box, or a sealing space, but embodiments of the present disclosure are not limited thereto.

The enclosure 300 can include one or more materials of a metal material or a nonmetal material (or a complex nonmetal material), but embodiments of the present disclosure are not limited thereto. For example, the enclosure 300 can include one or more materials of a metal material, plastic, fiber, carbon, and wood, but embodiments of the present disclosure are not limited thereto. For example, the enclosure 300 can include a plastic material or a plastic material of a styrene material, but embodiments of the present disclosure are not limited thereto. For example, the plastic material of the enclosure 300 can include polyethylene terephthalate, polycarbonate, polyimide, polyimide, polypropylene, polyarylate, polyethersulfone, polyethylene naphthalate, polysulfone, cyclo-olefin copolymer, or carbon fiber reinforced plastic (CFRP), but embodiments of the present disclosure are not limited thereto. For example, the styrene material of the enclosure 300 can be an ABS material. The ABS material can be acrylonitrile, butadiene, and styrene, but embodiments of the present disclosure are not limited thereto.

The enclosure 300 according to an embodiment of the present disclosure can include a bottom portion 310 and a supporting portion 320.

The bottom portion 310 can be configured (or disposed) in parallel with the vibration member 100, but embodiments are not limited thereto. The bottom portion 310 can be configured (or disposed) in parallel with the vibration member 100 with the vibration device 200 therebetween. The bottom portion 310 can be disposed to face the second surface 100b (or the rear surface) of the vibration member 100. The bottom portion 310 can include an inner surface 310i facing the vibration member 100, and the vibration member 100 can be configured in parallel with the inner surface 310i of the bottom portion 310. The bottom portion 310 can include a polygonal shape including a curved portion or a rectangular shape, but embodiments of the present disclosure are not limited thereto.

The supporting portion 320 can be configured to support an edge portion of the vibration member 100. For example, the supporting portion 320 can be in a shape of a stepped portion, a ledge shape or inward facing flange shape, but embodiments are not limited thereto. The supporting portion 320 can be configured or disposed at the edge portion of the vibration member 100. The supporting portion 320 can be connected to an edge portion of the bottom portion 310. For example, the supporting portion 320 can be configured to protrude vertically from the edge portion of the bottom portion 310 and support the edge portion of the vibration member 100. The supporting portion 320 can be configured to have a certain height from the inner surface 310i of the bottom portion 310. For example, the supporting portion 320 can be configured to have a first height H1 from the inner surface 310i of the bottom portion 310.

The supporting portion 320 can be provided as one body with the bottom portion 310. For example, the bottom portion 310 and the supporting portion 320 can be provided as one body. Therefore, the internal space 300s surrounded by the supporting portion 320 can be provided on the bottom portion 310. Accordingly, the enclosure 300 can include a box shape where one side (or an upper side) thereof is opened by the bottom portion 310 and the supporting portion 320. For example, the bottom portion 310 and supporting portion 320 together can form a five sided box space, in which one side or face remains open for receiving the vibration member 100, which can form the sixth face.

The enclosure 300 can be connected or coupled to the vibration member 100 by using a coupling member 350. The enclosure 300 can be connected or coupled to the second surface 100b (or the rear surface) of the vibration member 100 by using the coupling member 350. For example, the enclosure 300 can be connected or coupled to an edge portion of the second surface 100b of the vibration member 100 by using the coupling member 350.

The coupling member 350 according to an embodiment of the present disclosure can be configured to minimize or prevent the transfer of a vibration of the vibration member 100 to the enclosure 300. The coupling member 350 can include a material characteristic suitable for blocking of a vibration. For example, the coupling member 350 can include a material having elasticity. For example, the coupling member 350 can include a material having elasticity for vibration absorption (or impact absorption). The coupling member 350 according to an embodiment of the present disclosure can include a polyurethane material or a polyolefin material, but embodiments of the present disclosure are not limited thereto. For example, the coupling member 350 can include one or more of an adhesive, a double-sided adhesive, a double-sided tape, a double-sided adhesive tape, a double-sided foam tape, a double-sided adhesive foam tape, a double-sided pad, a double-sided foam pad, a double-sided adhesive foam pad, and a double-sided cushion tape, but embodiments of the present disclosure are not limited thereto.

According to another embodiment of the present disclosure, the coupling member 350 can minimize or prevent the transfer of a vibration of the vibration member 100 to the enclosure 300 and can be configured to decrease the reflection of a sound wave which is generated based on a vibration of the vibration member 100 and is incident thereon.

The enclosure 300 can include the internal space 300s, and the vibration member 100 can be connected or coupled to the supporting portion 320 of the enclosure 300 by the coupling member 350 to cover the internal space 300s of the enclosure 300. For example, the internal space 300s of the enclosure 300 can be surrounded by the bottom portion 310, the supporting portion 320, and the vibration member 100. The internal space 300s of the enclosure 300 can be configured to have a certain height up to the second surface 100b (or the rear surface) of the vibration member 100 from the bottom portion 310. For example, the internal space 300s of the enclosure 300 can be configured to have a second height H2 up to the second surface 100b (or the rear surface) of the vibration member 100 from the bottom portion 310 (e.g., H2>H1).

The guide protrusion portion 400 can be configured to protrude from the enclosure 300 to surround the edge portion of the vibration member 100. The guide protrusion portion 400 can be configured to protrude in a direction from an outer surface 320e of the enclosure 300 to the first surface 100a (or the front surface) of the vibration member 100. For example, the guide protrusion portion 400 can be configured to protrude in a direction from the outer surface 320c of the supporting portion 320 of the enclosure 300 to the first surface 100a (or the front surface) of the vibration member 100. The guide protrusion portion 400 can vertically protrude with respect to the vibration member 100. The guide protrusion portion 400 can be provided as one body with the enclosure 300. For example, the guide protrusion portion 400 can be provided as one body with the supporting portion 320 of the enclosure 300. The guide protrusion portion 400 can protrude vertically from the outer surface 320c of the supporting portion 320 to surround the edge portion of the vibration member 100 coupled to the supporting portion 320, in the supporting portion 320 of the enclosure 300. Accordingly, an open space surrounded by the guide protrusion portion 400 can be provided on the first surface 100a (or the front surface) of the vibration member 100. For example, the guide protrusion portion 400 can be a path through which a sound generated (or output) by the vibration device 200 connected to the vibration member 100 is output to the outside (e.g., the guide protrusion portion 400 can face toward a user). Also, according to an embodiment, the guide protrusion portion 400 can have a funnel shape or cone shape that has a width that increases as a distance away from the vibration member 100 increases, but embodiments are not limited thereto. For example, according to another embodiment, the guide protrusion portion 400 can have a funnel shape or cone shape that has a width that decreases as a distance away from the vibration member 100 increases, in order to provide or direct sound that is more focused on a specific user or arca.

The guide protrusion portion 400 can include a plurality of guide sidewalls 410. For example, the plurality of guide sidewalls 410 can include four guide sidewalls 410 connected to each other along the outer surface 320c of the enclosure 300. The plurality of guide sidewalls 410 can be configured to have a certain height from the second surface 100b of the vibration member 100. For example, the plurality of guide sidewalls 410 can be configured to have a third height H3 from the second surface 100b of the vibration member 100. For example, the plurality of guide sidewalls 410 can include a first guide sidewall, a second guide sidewall facing the first guide sidewall, a third guide sidewall facing the first and second guide sidewalls, and a fourth guide sidewall facing the third guide sidewall. For example, the first to fourth guide sidewalls can be configured to have the same third height H3 from the second surface 100b of the vibration member 100.

The sound apparatus 10 according to an embodiment of the present disclosure can include the vibration device 200 connected to the second surface 100b (or the rear surface) of the vibration member 100 and can include the guide protrusion portion 400 which protrudes to surround the vibration member 100 in a direction toward the first surface 100a (or the front surface) of the vibration member 100, and thus, can enhance a sound characteristic and/or a sound pressure level characteristic of a middle-high pitched sound band and can output a sound having a narrow orientation in the middle-high pitched sound band. For example, the sound apparatus 10 according to an embodiment of the present disclosure can output a sound generated based on a vibration (or displacement or driving) of the vibration device 200 including a piezoelectric material and can thus output a sound of the middle-high pitched sound band. The sound apparatus 10 according to an embodiment of the present disclosure can include the guide protrusion portion 400 which protrudes to surround the vibration member 100 in a direction toward the first surface 100a (or the front surface) of the vibration member 100 and can thus allow a sound, spreading to a periphery thereof from the first surface 100a (or the front surface) of the vibration member 100 through the guide protrusion portion 400, to concentrate (or reflect or funnel) in a direction toward a center portion thereof, thereby outputting a sound having a narrow orientation in the middle-high pitched sound band. For example, an upper surface of the vibration member 100 and the plurality of guide sidewalls 410 (e.g., walled portion) can form a bowl shape, a concave shape, an open box shape or a trough shape, which is configured to direct sound waves in a specific direction towards a user which can improve sound quality and enhance the user experience. Also, the guide sidewalls can space other objects away from the vibration member 100 so that the vibration member 100 can operate without any impediments (e.g., the guide sidewalls can prevent inner portions of a seat or chair from contacting or pressing against the vibration member 100).

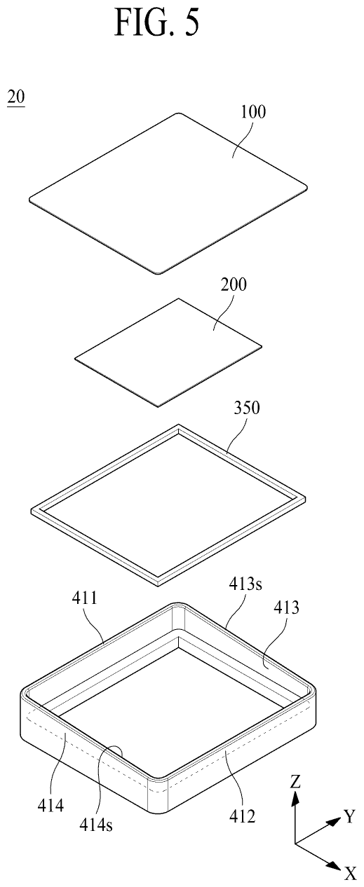

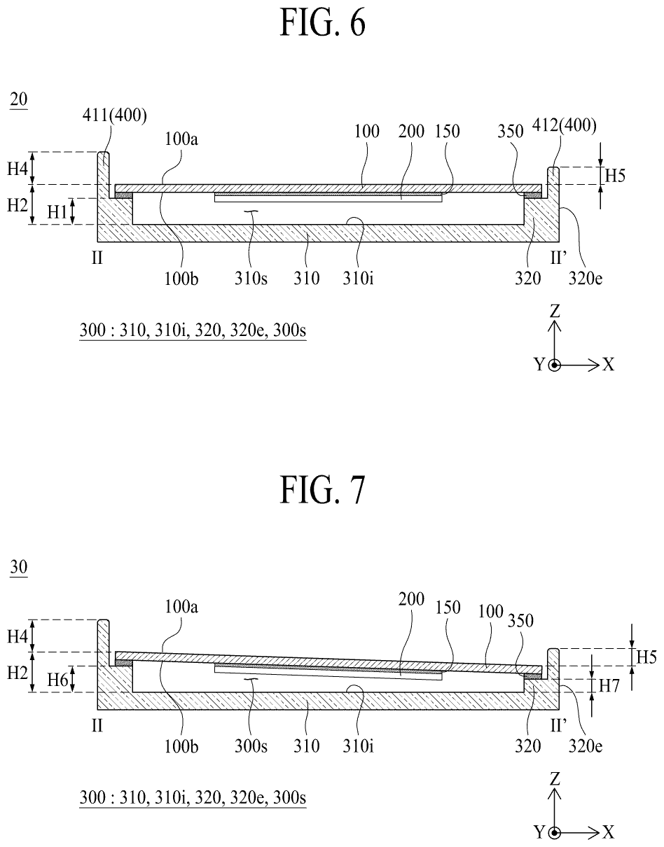

FIG. 4 is a diagram illustrating a sound apparatus 20 according to another embodiment of the present disclosure. FIG. 5 is an exploded perspective view of the sound apparatus illustrated in FIG. 4 according to another embodiment of the present disclosure. FIG. 6 is a cross-sectional view taken along line II-II′ illustrated in FIG. 4 according to another embodiment of the present disclosure.

Referring to FIGS. 4 to 6, the sound apparatus 20 according to another embodiment of the present disclosure can include a vibration member 100, a vibration device 200, an enclosure 300, and a guide protrusion portion 400. FIGS. 4 to 6 illustrate an embodiment implemented by modifying a configuration of the guide protrusion portion 400 in the sound apparatus 10 described above with reference to FIGS. 1 to 3. Therefore, in the following description, like reference numerals refer to like elements except a configuration of the guide protrusion portion 400, and thus, their repeated descriptions can be omitted or will be briefly given.

Referring to FIGS. 4 to 6, according to another embodiment of the present disclosure, the guide protrusion portion 400 can be configured to have different heights. The guide protrusion portion 400 can include a plurality of guide sidewalls 411 to 414. The plurality of guide sidewalls 411 to 414 can be configured to have different heights from a first surface 100a (or a front surface) of the vibration member 100. For example, the different heights of the guide walls can help tilt the vibration member 100 and/or funnel sound in a diagonal direction, which can improve the user experience.

The plurality of guide sidewalls 411 to 414 can include a first guide sidewall 411, a second guide sidewall 412 facing the first guide sidewall 411, a third guide sidewall 413 between the first and second guide sidewalls 411 and 412, and a fourth guide sidewall 414 facing the third guide sidewall 413. The first guide sidewall 411 and the second guide sidewall 412 can be configured to have different heights. For example, the first guide sidewall 411 can be configured to have a fourth height H4 from the first surface 100a (or the front surface) of the vibration member 100. The second guide sidewall 412 can be configured to have a fifth height H5, which is lower than the fourth height H4, from the first surface 100a (or the front surface) of the vibration member 100 (e.g., H5<H4). The third guide sidewall 413 and the fourth guide sidewall 414 can be configured to have a slope surface based on a height difference between the first guide sidewall 411 and the second guide sidewall 412. For example, the third guide sidewall 413 can include a slope surface 413s which is inclined from the fourth height H4 to the third height H3, and the fourth guide sidewall 414 can include a slope surface 414s which is inclined from the fourth height H4 to the third height H3. For example, each of the first guide sidewall 411 and the second guide sidewall 412 can have a triangular shape or a trapezoid shape (e.g., due to the inclined upper edge).

The sound apparatus 20 according to another embodiment of the present disclosure can include the vibration device 200 connected to a second surface 100b (or a rear surface) of the vibration member 100 and can include the guide protrusion portion 400 which surrounds the vibration member 100 toward the first surface 100a (or the front surface) of the vibration member 100 and protrudes by different heights, and thus, can enhance a sound characteristic and/or a sound pressure level characteristic of a middle-high pitched sound band and can output a sound which has a narrow orientation in the middle-high pitched sound band and has a specific orientation angle. For example, the sound apparatus 20 according to another embodiment of the present disclosure can output a sound generated based on a vibration (or displacement or driving) of the vibration device 200 including a piezoelectric material and can thus output a sound of the middle-high pitched sound band and funnel the sound in a specific direction (e.g., a tilted or diagonal direction). The sound apparatus 20 according to another embodiment of the present disclosure can include the guide protrusion portion 400 which surrounds the vibration member 100 in a direction toward the first surface 100a (or the front surface) of the vibration member 100 and protrudes by different heights and can thus allow a sound, spreading to a periphery thereof from the first surface 100a (or the front surface) of the vibration member 100 through the guide protrusion portion 400, to concentrate (or reflect) with a specific orientation angle, thereby outputting a sound which has a narrow orientation in the middle-high pitched sound band and has a specific orientation angle.

FIG. 7 is another cross-sectional view taken along line II-II′ illustrated in FIG. 4 according to another embodiment of the present disclosure.

Referring to FIG. 7, a sound apparatus 30 according to another embodiment of the present disclosure can include a vibration member 100, a vibration device 200, an enclosure 300, and a guide protrusion portion 400. FIG. 7 illustrates an embodiment implemented by modifying configurations of the guide protrusion portion 400 and the enclosure 300 in the sound apparatuses 10 and 20 described above with reference to FIGS. 1 to 6. Therefore, in the following description, like reference numerals refer to like elements except configurations of the guide protrusion portion 400 and the enclosure 300, and thus, their repeated descriptions can be omitted or will be briefly given.

Referring to FIG. 7, according to another embodiment of the present disclosure, the enclosure 300 can include an inner surface 310i facing the vibration member 100, and the vibration member 100 can be configured to be inclined (e.g., tilted) with respect to an inner surface 310i of the enclosure 300.

The enclosure 300 according to another embodiment of the present disclosure can include a bottom portion 310 and a supporting portion 320, and the supporting portion 320 can be configured to have different heights from the inner surface 310i of the bottom portion 310. For example, a portion of the supporting portion 320 can be configured to have a sixth height H6 from the inner surface 310i of the bottom portion 310, and another portion, facing the portion, of the supporting portion 320 can be configured to have a seventh height H7, which is lower than the sixth height H6, from the inner surface 310i of the bottom portion 310 (e.g., H7<H6). Therefore, the vibration member 100 can be configured to be inclined or tilted based on a height difference between the portion of the supporting portion 320 and the other portion of the supporting portion 320. The sound apparatus 30 according to another embodiment of the present disclosure can be configured so that the guide protrusion portion 400 has different heights, and the vibration member 100 can be configured to be inclined or tilted to correspond to a slope surface based on a height difference of the guide protrusion portion 400.

The sound apparatus 30 according to another embodiment of the present disclosure can include the vibration device 200 connected to a second surface 100b (or a rear surface) of the vibration member 100 and can include the guide protrusion portion 400 which surrounds the vibration member 100 toward the first surface 100a (or the front surface) of the vibration member 100 and protrudes by different heights, and the vibration member 100 can be configured to be inclined, and thus, a sound characteristic and/or a sound pressure level characteristic of a middle-high pitched sound band can be enhanced, thereby outputting a sound which has a narrow orientation in the middle-high pitched sound band and has a specific orientation angle, which can improve sound quality and enhance the user experience. For example, the sound apparatus 30 according to another embodiment of the present disclosure can output a sound generated based on a vibration (or displacement or driving) of the vibration device 200 including a piezoelectric material and can thus output a sound of the middle-high pitched sound band. The sound apparatus 30 according to another embodiment of the present disclosure can include the guide protrusion portion 400 which surrounds the vibration member 100 in a direction toward the first surface 100a (or the front surface) of the vibration member 100 and protrudes by different heights and can thus allow a sound, spreading to a periphery thereof from the first surface 100a (or the front surface) of the vibration member 100 through the guide protrusion portion 400, to concentrate (or reflect) with a specific orientation angle, thereby outputting a sound which has a narrow orientation in the middle-high pitched sound band and has a specific orientation angle.

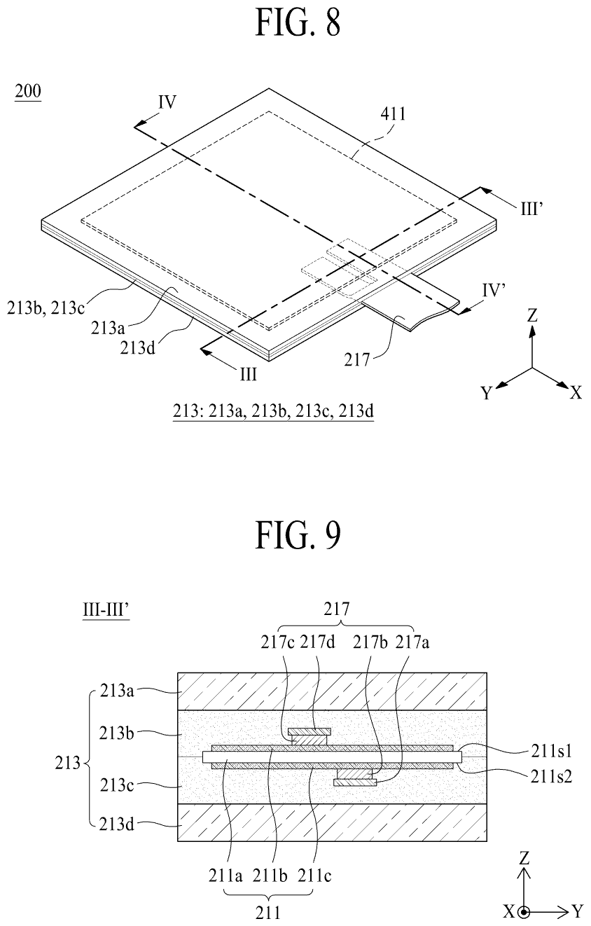

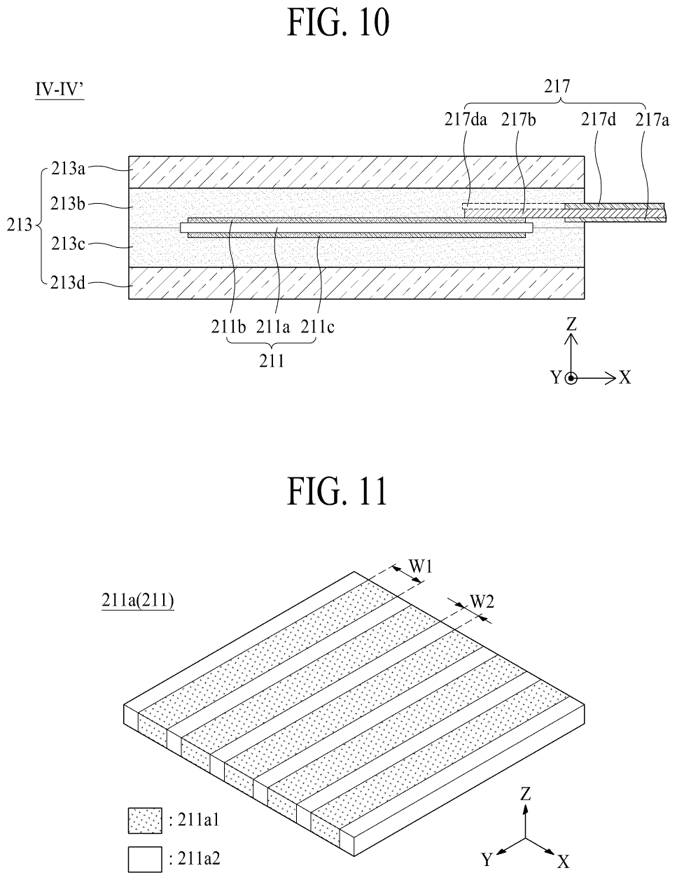

FIG. 8 is a diagram illustrating a vibration device 200 according to an embodiment of the present disclosure. FIG. 9 is a cross-sectional view taken along line III-III′ illustrated in FIG. 8 according to an embodiment of the present disclosure. FIG. 10 is a cross-sectional view taken along line IV-IV′ illustrated in FIG. 8 according to an embodiment of the present disclosure. For example, FIGS. 8 to 10 illustrate the vibration device described above with reference to FIGS. 1 to 7.

Referring to FIGS. 8 to 10, the vibration device 200 according to an embodiment of the present disclosure can include a piezoelectric material having a piezoelectric characteristic.

The vibration device 200 can include a ceramic-based piezoelectric material capable of implementing a relatively strong vibration, or can include piezoelectric ceramic having a perovskite-based crystalline structure.

The vibration device 200 according to an embodiment of the present disclosure can include a vibration part 211.

The vibration part 211 can be configured to vibrate based on a piezoelectric effect based on a driving signal. The vibration part 211 can include one or more of a piezoelectric inorganic material and a piezoelectric organic material. For example, the vibration part 211 can be a vibration device, a piezoelectric device layer, a piezoelectric structure material, a piezoelectric vibration part, or a piezoelectric vibration layer, but embodiments of the present disclosure are not limited thereto.

The vibration part 211 according to an embodiment of the present disclosure can include a vibration layer 211a, a first electrode layer 211b, and a second electrode layer 211c.

The vibration layer 21 la can include a piezoelectric material or an electro active material having a piezoelectric effect. For example, the piezoelectric material can have a characteristic where pressure or twisting is applied to a crystalline structure by an external force, a potential difference occurs due to dielectric poling caused by a relative position change of a positive (+) ion and a negative (−) ion, and a vibration is generated by an electric field based on a voltage applied thereto. For example, the vibration layer 211a can be a piezoelectric layer, a piezoelectric material layer, an electro active layer, a piezoelectric composite layer, a piezoelectric composite, or a piezoelectric ceramic composite, but embodiments of the present disclosure are not limited thereto.

The vibration layer 211a according to an embodiment of the present disclosure can include a ceramic-based material capable of implementing a relatively strong vibration, or can include piezoelectric ceramic having a perovskite-based crystalline structure. The perovskite crystalline structure can have a piezoelectric effect and/or an inverse piezoelectric effect and can be a plate-shaped structure having an orientation.

The piezoelectric ceramic can include single crystalline ceramic having a single crystalline structure, or can include a ceramic material or polycrystalline ceramic having a polycrystalline structure. A piezoelectric material of the single crystalline ceramic can include α-AlPO₄, α-SiO₂, LiNbO₃, Tb₂(MoO₄)₃, Li₂B₄O₇, or ZnO, but embodiments of the present disclosure are not limited thereto. A piezoelectric material of the polycrystalline ceramic can include a lead zirconate titanate (PZT)-based material including lead (Pb), zirconium (Zr), and titanium (Ti) or can include a lead zirconate nickel niobate (PZNN)-based material including lead (Pb), zirconium (Zr), nickel (Ni), and niobium (Nb), but embodiments of the present disclosure are not limited thereto. For example, the vibration layer 211a can include at least one of CaTiO₃, BaTiO₃, and SrTiO₃ including no Pb, but embodiments of the present disclosure are not limited thereto.

The first electrode layer 211b can be disposed at a first surface (or an upper surface or a front surface) 211s1 of the vibration layer 211a. The first electrode layer 211b can have a size which is equal to that of the vibration layer 211a, or can have a size which is less than that of the vibration layer 211a, but embodiments of the present disclosure are not limited thereto.

The second electrode layer 211c can be disposed at a second surface (or a lower surface or a rear surface) 211s2, differing from the first surface 211s1, of the vibration layer 211a. The second electrode layer 211c can have a size which is equal to that of the vibration layer 211a, or can have a size which is less than that of the vibration layer 211a, but embodiments of the present disclosure are not limited thereto. For example, the second electrode layer 211c can have the same shape as that of the vibration layer 211a, but embodiments of the present disclosure are not limited thereto.

One or more of the first electrode layer 211b and the second electrode layer 211c according to an embodiment of the present disclosure can include a transparent conductive material, a semitransparent conductive material, or an opaque conductive material. For example, the transparent or semitransparent conductive material can include indium tin oxide (ITO) or indium zinc oxide (IZO), but embodiments of the present disclosure are not limited thereto. The opaque conductive material can include gold (Au), silver (Ag), platinum (Pt), palladium (Pd), molybdenum (Mo), magnesium (Mg), carbon, or Ag containing glass frit, or can include an alloy thereof, but embodiments of the present disclosure are not limited thereto. For example, each of the first electrode layer 211b and the second electrode layer 211c can include Ag having low resistivity, to enhance an electrical characteristic and/or a vibration characteristic of the vibration layer 211a. For example, the carbon can include a carbon material including graphite, carbon black, ketjen black, and carbon nano tube, but embodiments of the present disclosure are not limited thereto.

The vibration layer 211a can be poled (or polarized) by a certain voltage applied to the first electrode layer 211b and the second electrode layer 211c in a certain temperature atmosphere or a temperature atmosphere which is changed from a high temperature to a room temperature, but embodiments of the present disclosure are not limited thereto. For example, a poling direction (or a polarization direction) formed in the vibration layer 211a can be formed or oriented (or aligned) from the first electrode layer 211b to the second electrode layer 211c, but is not limited thereto and can be formed or oriented (or aligned) from the second electrode layer 211c to the first electrode layer 211b.

The vibration layer 211a can alternately repeat contraction and/or expansion, based on an inverse piezoelectric effect based on a driving signal applied to the first electrode layer 211b and the second electrode layer 211c, and thus, can vibrate. For example, the vibration layer 211a can vibrate in a vertical direction (or a thickness direction) and a horizontal direction, based on a signal applied to the first electrode layer 211b and the second electrode layer 211c. The vibration layer 211a can be displaced (or vibrated or driven) by contraction and/or expansion in the horizontal direction, and thus, can enhance a vibration characteristic including a sound characteristic and/or a sound pressure level characteristic of the vibration device 200.

The vibration device 200 according to an embodiment of the present disclosure can further include a cover member 213.

The cover member 213 can be configured to cover one or more of a first surface and a second surface of the vibration part 211. The cover member 213 can be configured to protect one or more of the first surface and the second surface of the vibration part 211. For example, the first surface of the vibration part 211 can be a front surface or an upper surface. For example, the second surface of the vibration part 211 can be a rear surface or a lower surface, which is opposite to the first surface, of the vibration part 211. For example, the vibration part 211 can be sealed within and fully enclosed by the cover member 213, but embodiments are not limited thereto.

The cover member 213 according to an embodiment of the present disclosure can include a first cover member 213a.

The first cover member 213a can be disposed at the first surface of the vibration part 211. For example, the first cover member 213a can be configured to cover the first electrode layer 211b of the vibration part 211. For example, the first cover member 213a can be configured to have a size which is greater than that of the vibration part 211, but embodiments of the present disclosure are not limited thereto. The first cover member 213a can be configured to protect the first electrode layer 211b and the first surface of the vibration part 211.

The first cover member 213a according to an embodiment of the present disclosure can include an adhesive layer. For example, the first cover member 213a can include a base film and the adhesive layer which is in the base film and is connected or coupled to the first surface of the vibration part 211. For example, the adhesive layer can include an electrical insulating material which has adhesive properties and is capable of compression and decompression, but embodiments of the present disclosure are not limited thereto.

According to another embodiment of the present disclosure, the first cover member 213a can be connected or coupled to the first surface of the vibration part 211 by a first adhesive layer 213b. For example, the first cover member 213a can be connected or coupled to the first electrode layer 211b or the first surface of the vibration part 211 by the first adhesive layer 213b. For example, the first cover member 213a can be connected or coupled to the first electrode layer 211b or the first surface of the vibration part 211 by a film laminating process using the first adhesive layer 213b. The first adhesive layer 213b can be configured to surround the entire first surface of the vibration part 211 and a portion of a lateral surface of the vibration part 211.

The cover member 213 according to an embodiment of the present disclosure can further include a second adhesive layer 213c.

The second adhesive layer 213c can be disposed at the second surface of the vibration part 211. For example, the second adhesive layer 213c can be configured to cover the second electrode layer 211c of the vibration part 211. The second adhesive layer 213c can be configured to protect the second electrode layer 211c and the second surface of the vibration part 211. The second adhesive layer 213c can be configured to surround the entire second surface of the vibration part 211 and a portion of a lateral surface of the vibration part 211. For example, the second adhesive layer 213c can be a protection layer or a protection member, but embodiments of the present disclosure are not limited thereto.

The second adhesive layer 213c can be connected or coupled to the first adhesive layer 213b at the lateral surface of the vibration part 211 or an edge portion of the first cover member 213a. Therefore, the first adhesive layer 213b and the second adhesive layer 213c can be configured to surround or entirely surround the vibration part 211. The first adhesive layer 213b and the second adhesive layer 213c can be configured to cover or surround all surfaces of the vibration part 211. For example, the vibration part 211 can be inserted (or accommodated) or buried (or embedded) into the adhesive layer including the first adhesive layer 213b and the second adhesive layer 213c. For example, the vibration part 211 can be sealed within and fully enclosed by the adhesive layer including the first adhesive layer 213b and the second adhesive layer 213c, but embodiments are not limited thereto.

The cover member 213a according to an embodiment of the present disclosure can further include a second cover member 213d, but embodiments of the present disclosure are not limited thereto. The second cover member 213d can be disposed at the second surface of the vibration part 211. For example, the second cover member 213d can be configured to cover the second electrode layer 211c of the vibration part 211. For example, the second cover member 213d can be configured to have a size which is greater than that of the vibration part 211 and can be configured to have a size which is equal to that of the first cover member 213a, but embodiments of the present disclosure are not limited thereto. The second cover member 213d can be configured to protect the second surface and the second electrode layer 211c of the vibration part 211.

The first cover member 213a and the second cover member 213d according to an embodiment of the present disclosure can include the same or different materials. For example, each of the first cover member 213a and the second cover member 213d can be a polyimide film, a polyethylene naphthalate film, or a polyethylene terephthalate film, but embodiments of the present disclosure are not limited thereto.

The second cover member 213d can be connected or coupled to the second surface or the second electrode layer 211c of the vibration part 211 by the second adhesive layer 213c. For example, the second cover member 213d can be connected or coupled to the second electrode layer 211c or the second surface of the vibration part 211 by a film laminating process using the second adhesive layer 213c.

The vibration part 211 can be disposed or inserted (or accommodated) between the first cover member 213a and the second cover member 213d. For example, the vibration part 211 can be inserted (or accommodated) or buried (or embedded) into the adhesive layer including the first adhesive layer 213b and the second adhesive layer 213c, but embodiments of the present disclosure are not limited thereto.

Each of the first adhesive layer 213b and the second adhesive layer 213c according to an embodiment of the present disclosure can include an electrical insulating material which has adhesive properties and is capable of compression and decompression, but embodiments of the present disclosure are not limited thereto. For example, each of the first adhesive layer 213b and the second adhesive layer 213c can include epoxy resin, acrylic resin, silicone resin, urethane resin, pressure sensitive adhesive (PSA), optically cleared adhesive (OCA), or optically cleared resin (OCR), but embodiments of the present disclosure are not limited thereto.

The first adhesive layer 213b and the second adhesive layer 213c can be configured between the first cover member 213a and the second cover member 213d to surround the vibration part 211. For example, one or more of the first adhesive layer 213b and the second adhesive layer 213c can be configured to surround the vibration part 211.

The vibration device 200 according to an embodiment of the present disclosure can further include a signal supply member 217.

The signal supply member 217 can be configured to supply a piezoelectric driving signal, supplied from a driving circuit unit, to the vibration part 211. The signal supply member 217 can be configured to be electrically connected to the vibration part 211. The signal supply member 217 can be configured to be electrically connected to the first electrode layer 21 1b and the second electrode layer 211c of the vibration part 211.

A portion of the signal supply member 217 can be accommodated (or inserted) between the cover member 213 and the vibration part 211. For example, the signal supply member 217 can be accommodated (or inserted) between the first cover member 213a and the first surface of the vibration part 211. For example, a portion of the signal supply member 217 can be accommodated (or inserted) between the first cover member 213a and the second cover member 213d, but embodiments of the present disclosure are not limited thereto.

According to an embodiment of the present disclosure, an end portion (or distal end portion or one side) of the signal supply member 217 can be disposed or inserted (or accommodated) between one edge portion of the cover member 213 and the vibration part 211. For example, the end portion of the signal supply member 217 can be disposed or inserted (or accommodated) between one edge portion of the first cover member 213a and the first surface of the vibration part 211. For example, the signal supply member 217 can be configured as a signal cable, a flexible cable, a flexible printed circuit cable, a flexible flat cable, a single-sided flexible printed circuit, a single-sided flexible printed circuit board (PCB), a flexible multi-layer printed circuit, or a flexible multi-layer PCB, but embodiments of the present disclosure are not limited thereto. For example, the signal supply member 217 can have a flat film type configuration which can be inserted between the first adhesive layer 213b and the second adhesive layer 213c, in which the flat film configuration has split ends (e.g., pair of split ends) that can be disposed on opposite sides of the vibration part 211 (e.g., sec FIGS. 8 and 9).

The signal supply member 217 according to an embodiment of the present disclosure can include a base member 217a and a plurality of signal lines 217b and 217c. For example, the signal supply member 217 can include the base member 217a, a first signal line 217b, and a second signal line 217c.

The base member 217a can include a transparent or opaque plastic material, but embodiments of the present disclosure are not limited thereto.

The first and second signal lines 217b and 217c can be disposed at a first surface of the base member 217a and can be spaced apart from or electrically disconnected from each other. The first and second signal lines 217b and 217c can be disposed in parallel at the first surface of the base member 217a. For example, the first and second signal lines 217b and 217c can be formed at the first surface of the base member 217a, or can be implemented in a line shape by patterning a deposited metal layer (or conductive layer).

End portions or split ends (or distal end portions or one sides) of the first and second signal lines 217b and 217c can be isolated from each other, and thus, can be individually curved or bent.

The end portion of the first signal line 217b can be electrically connected to the first electrode layer 211b of the vibration part 211. For example, the end portion of the first signal line 217b can be electrically connected to at least a portion of the first electrode layer 211b of the vibration part 211 at one edge portion of the first cover member 213a. For example, the end portion of the first signal line 217b can be electrically and directly connected to at least a portion of the first electrode layer 211b of the vibration part 211. For example, the end portion of the first signal line 217b can be directly connected to or directly contact the first electrode layer 211b of the vibration part 211. For example, the end portion of the first signal line 217b can be electrically connected to the first electrode layer 211b through a double-sided conductive tape. Accordingly, the first signal line 217b can supply a first driving signal, supplied from a vibration driver, to the first electrode layer 211b of the vibration part 211.

The end portion of the second signal line 217c can be electrically connected to the second electrode layer 211c of the vibration part 211. For example, the end portion of the second signal line 217c can be electrically connected to at least a portion of the second electrode layer 211c of the vibration part 211 at one edge portion of the second cover member 213d. For example, the end portion of the second signal line 217c can be electrically and directly connected to at least a portion of the second electrode layer 211c of the vibration part 211. For example, the end portion of the second signal line 217c can be directly connected to or directly contact the second electrode layer 211c of the vibration part 211. For example, the end portion of the second signal line 217c can be electrically connected to the second electrode layer 211c through a double-sided conductive tape. Accordingly, the second signal line 217c can supply a second driving signal, supplied from the vibration driver, to the second electrode layer 211c of the vibration part 211.

The signal supply member 217 according to an embodiment of the present disclosure can further include an insulation layer 217d.

The insulation layer 217d can be disposed at a first surface of the base member 217a to cover each of the first signal line 217b and the second signal line 217c except for an end portion (or one side) of the signal supply member 217 (e.g., sec FIG. 10).

According to an embodiment of the present disclosure, an end portion (or one side) 217da of the insulation layer 217d and the end portion of the signal supply member 217 including the end portion (or one side) of the base member 217a can be inserted (or accommodated) between the cover member 213 and the vibration part 211 and can be fixed between the cover member 213a and the vibration part 211 by the first adhesive layer 213b and the second adhesive layer 213c.

According to another embodiment of the present disclosure, the end portion 217da of the insulation layer 217d and the end portion (or one side) of the signal supply member 217 including the end portion of the base member 217a can be inserted (or accommodated) between the first cover member 213a and the second cover member 213d and can be fixed between the first cover member 213a and the second cover member 213d by the first adhesive layer 213b and the second adhesive layer 213c. Therefore, the end portion of the first signal line 217b can be securely maintained with being electrically connected to the first electrode layer 211b of the vibration part 211, and the end portion of the second signal line 217c can be securely maintained with being electrically connected to the second electrode layer 211c of the vibration part 211. Also, the end portion of the signal supply member 217 can be inserted (or accommodated) and fixed between the vibration part 211 and the first cover member 213a, and thus, a connection defect between the vibration device 200 and the signal supply member 217 caused by a movement of the signal supply member 217 can be prevented.

In the signal supply member 217 according to an embodiment of the present disclosure, each of the end portion of the base member 217a and the end portion 217da of the insulation layer 217d can be removed or stripped. For example, each of the end portion of the first signal line 217b and the end portion of the second signal line 217c may not be supported or covered by each of the end portion of the base member 217a and the end portion 217da of the insulation layer 217d and can be exposed at the outside. For example, the end portion of each of the first and second signal lines 217b and 217c can protrude (or extend) to have a certain length from the end portion of the base member 217a or the end portion 217da of the insulation layer 217d. Accordingly, the end portion of each of the first and second signal lines 217b and 217c can be individually or independently bent.

The end portion of the first signal line 217b which is not to be supported by each of the end portion of the base member 217a and the end portion 217da of the insulation layer 217d can be directly connected to or directly contact the first electrode layer 211b of the vibration part 211. The end portion of the second signal line 217c which is not to be supported by each of the end portion of the base member 217a and the end portion 217da of the insulation layer 217d can be directly connected to or directly contact the second electrode layer 211c of the vibration part 211.

According to an embodiment of the present disclosure, a portion of the signal supply member 217 or a portion of the base member 217a can be disposed or inserted (or accommodated) between the cover member 213 and the vibration part 211, and thus, the signal supply member 217 can be provided as one body with the vibration device 200. For example, a portion of the signal supply member 217 or a portion of the base member 217a can be disposed or inserted (or accommodated) between the first cover member 213a and the second cover member 213d, and thus, the signal supply member 217 can be provided as one body with the vibration device 200. Accordingly, the vibration device 200 and the signal supply member 217 can be configured as one element, and thus, an effect of uni-materialization can be obtained.

According to an embodiment of the present disclosure, the first signal line 217b and the second signal line 217c of the signal supply member 217 can be provided as one body with the vibration device 200, and thus, a soldering process for an electrical connection between the vibration device 200 and the signal supply member 217 may not be needed, and thus, a manufacturing process and a structure of the vibration device 200 can be simplified, thereby improving a harmful process and increasing manufacturing efficiency.

FIG. 11 is a diagram illustrating a vibration part according to another embodiment of the present disclosure. For example, FIG. 11 illustrates another embodiment of the vibration layer described above with reference to FIGS. 8 to 10.

Referring to FIGS. 9 and 11, a vibration layer 211a according to another embodiment of the present disclosure can include a plurality of first portions 211a1 and a plurality of second portions 211a2. For example, the plurality of first portions 211a1 and the plurality of second portions 211a2 can be alternately and repeatedly arranged in a first direction X (or a second direction Y).

Each of the plurality of first portions 211a1 can include an inorganic material having a piezoelectric effect (or a piezoelectric characteristic). For example, each of the plurality of first portions 211a1 can include one or more of a piezoelectric inorganic material and a piezoelectric organic material. For example, each of the plurality of first portions 211a1 can be an inorganic portion, an inorganic material portion, a piezoelectric portion, a piezoelectric material portion, or an electro active portion, but embodiments of the present disclosure are not limited thereto.

According to an embodiment of the present disclosure, each of the plurality of first portions 211a1 can have a first width W1 parallel to a first direction X (or a second direction Y) and can extend in the second direction Y (or the first direction X). Each of the plurality of first portions 211a1 can be substantially the same as the vibration layer 211a described above with reference to FIGS. 8 to 10, and thus, its repeated description can be omitted.

Each of the plurality of second portions 211a2 can be disposed between the plurality of first portions 211a1. For example, each of the plurality of first portions 211a1 can be disposed between two adjacent second portions 211a2 of the plurality of second portions 211a2. Each of the plurality of second portions 211a2 can have a second width W2 parallel to the first direction X (or the second direction Y) and can extend in the second direction Y (or the first direction X). The first width W1 can be equal to or different from the second width W2. For example, the first width W1 can be greater than the second width W2. For example, the first portion 211a1 and the second portion 211a2 can include a line shape or a stripe shape having the same or different sizes, but embodiments of the present disclosure are not limited thereto. Accordingly to another embodiment, the plurality of first portions 211a1 and the plurality of second portions 211a2 can have varying widths (e.g., the widths can become larger or smaller along the X direction), but embodiments are not limited thereto.

Each of the plurality of second portions 211a2 can be configured to fill a gap between two adjacent first portions 211a1. Each of the plurality of second portions 211a2 can be configured to fill a gap between two adjacent first portions 211a1, and thus, can be connected to or contact a lateral surface of an adjacent first portion 211a1. According to an embodiment of the present disclosure, each of the plurality of first portions 211a1 and the plurality of second portions 211a2 can be disposed (or arranged) in parallel in the same plane (or the same layer). Accordingly, the vibration layer 211a can be enlarged by a desired size or length, based on lateral coupling (or connection) between the first portion 211a1 and the second portion 211a2.

According to an embodiment of the present disclosure, each of the plurality of second portions 211a2 can absorb an impact applied to the first portion 211a1, and thus, can enhance the durability of the first portion 211a1 and can provide flexibility to the vibration layer 211a. Each of the plurality of second portions 211a2 can include an organic material having a ductile characteristic. For example, the plurality of second portions 211a2 can include one or more of an epoxy-based polymer, an acrylic polymer, and a silicone-based polymer, but embodiments of the present disclosure are not limited thereto. For example, each of the plurality of second portions 211a2 can be an organic portion, an organic material portion, an adhesive portion, an elastic portion, a bending portion, a damping portion, or a ductile portion, but embodiments of the present disclosure are not limited thereto.

A first surface of each of the plurality of first portions 211a1 and the plurality of second portions 211a2 can be connected to a first electrode layer 211b in common. A second surface of each of the plurality of first portions 211a1 and the plurality of second portions 211a2 can be connected to the second electrode layer 211c in common.

The vibration layer 211a according to another embodiment of the present disclosure can have a single thin film type because the plurality of first portions 211a1 and the plurality of second portions 211a2 are disposed on (or connected to) the same plane. Therefore, a vibration device 200 or a vibration part 211 including the vibration layer 211a according to another embodiment of the present disclosure can be vibrated by the first portion 211a1 and can be bent in a curved shape by the second portion 211a2 having flexibility.

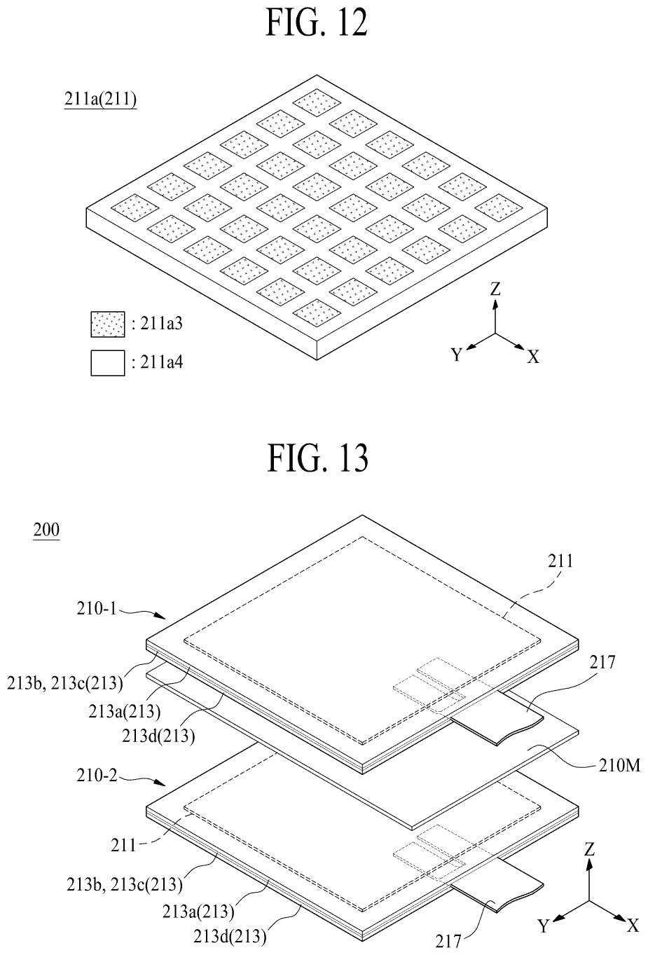

FIG. 12 is a diagram illustrating a vibration part according to another embodiment of the present disclosure. For example, FIG. 12 illustrates another embodiment of the vibration layer described above with reference to FIGS. 8 to 10.

Referring to FIGS. 9 and 12, a vibration layer 211a according to another embodiment of the present disclosure can include a plurality of first portions 211a3 and a second portion 211a4 between the plurality of first portions 211a3.

The plurality of first portions 211a3 can be disposed apart from one another in each of a first direction X and a second direction Y. For example, the plurality of first portions 211a3 can be arranged in a lattice shape or a gird configuration to have a hexahedral shape having the same size, but embodiments of the present disclosure are not limited thereto. For example, each of the plurality of first portions 211a3 can have a circular plate shape, an oval plate shape, or a polygonal plate shape having the same size, but embodiments of the present disclosure are not limited thereto.

Each of the plurality of first portions 211a3 can be substantially the same as the first portion 211a1 described above with reference to FIG. 11, and thus, its repeated description can be omitted.

The second portion 211a4 can be disposed between the plurality of first portions 211a3 in each of the first direction X and the second direction Y. The second portion 211a4 can be configured to fill a gap between two adjacent first portions 211a3 or surround each of the plurality of first portions 211a3, and thus, can be connected to or contact an adjacent first portion 211a3. The second portion 211a4 can be substantially the same as the second portion 211a2 described above with reference to FIG. 11, and thus, its repeated description can be omitted.

A first surface of each of the plurality of first portions 211a3 and the second portion 211a4 can be connected to a first electrode layer 211b in common. A second surface of each of the plurality of first portions 211a3 and the second portion 211a4 can be connected to the second electrode layer 211c in common.

The vibration layer 211a according to another embodiment of the present disclosure can have a single thin film type because the plurality of first portions 211a3 and the second portion 211a4 are disposed on (or connected to) the same plane, but embodiments of the present disclosure are not limited thereto. Therefore, a vibration device 200 or a vibration part 211 including the vibration layer 211a according to another embodiment of the present disclosure can be vibrated by the first portion 211a3 and can be bent in a curved shape by the second portion 211a4 having flexibility.

FIG. 13 is a diagram illustrating a vibration device 200 according to another embodiment of the present disclosure. For example, FIG. 13 illustrates another embodiment of the vibration layer described above with reference to FIGS. 1 to 7.

Referring to FIG. 13, the vibration device 200 according to another embodiment of the present disclosure can include two or more vibration generating units 210-1 and 210-2 stacked on top of each other. For example, the vibration device 200 can include a first vibration generating unit 210-1 and a second vibration generating unit 210-2.

The first vibration generating unit 210-1 and the second vibration generating unit 210-2 can be stacked or overlap each other to be displaced (or driven or vibrated) in the same direction, to maximize an amplitude displacement of the vibration device 200 and/or an amplitude displacement of a vibration member. For example, the first vibration generating unit 210-1 and the second vibration generating unit 210-2 can have substantially the same size, but embodiments of the present disclosure are not limited thereto. For example, the first vibration generating unit 210-1 and the second vibration generating unit 210-2 can have substantially the same size within an error range of a manufacturing process. Accordingly, the first vibration generating unit 210-1 and the second vibration generating unit 210-2 can maximize the amplitude displacement of the vibration device 200 and/or the amplitude displacement of the vibration member.

Each of the first vibration generating unit 210-1 and the second vibration generating unit 210-2 can be the same or substantially the same as the vibration device 200 described above with reference to FIGS. 8 to 12, and thus, its repeated description can be omitted.

The vibration device 200 according to another embodiment of the present disclosure can further include a middle member 210M.

The middle member 210M can be disposed or connected between the first vibration generating unit 210-1 and the second vibration generating unit 210-2. In an embodiment of the present disclosure, the middle member 210M can be disposed or connected between a second adhesive layer 213c of the first vibration generating unit 210-1 and a first cover member 213a of the second vibration generating unit 210-2. In another embodiment of the present disclosure, the middle member 210M can be disposed or connected between a second cover member 213d of the first vibration generating unit 210-1 and the first cover member 213a of the second vibration generating unit 210-2. For example, the middle member 210M can be a middle adhesive member, an adhesive member, or a connection member, but embodiments of the present disclosure are not limited thereto.

The middle member 210M according to an embodiment of the present disclosure can include a material including an adhesive layer which is good in sticky force or adhesive force, with respect to each of the first vibration generating unit 210-1 and the second vibration generating unit 210-2, but embodiments of the present disclosure are not limited thereto. For example, the middle member 210M can include a foam pad, a double-sided tape, a double-sided foam tape, a double-sided foam pad, a double-sided adhesive tape, or an adhesive, but embodiments of the present disclosure are not limited thereto. For example, the adhesive layer of the middle member 210M can include epoxy, acryl, silicone, or urethane, but embodiments of the present disclosure are not limited thereto. For example, the adhesive layer of the middle member 210M can include a urethane-based material (or substance) relatively having a ductile characteristic. Accordingly, the loss of a vibration caused by displacement interference between the first vibration generating unit 210-1 and the second vibration generating unit 210-2 can be minimized, or each of the first vibration generating unit 210-1 and the second vibration generating unit 210-2 can be freely displaced (or vibrated or driven).

The vibration device 200 according to another embodiment of the present disclosure can include the first vibration generating unit 210-1 and the second vibration generating unit 210-2 which are stacked (or overlap or piled) to vibrate (or displace or drive) in the same direction, and thus, the amount of displacement or an amplitude displacement can be maximized or increased. Accordingly, the amount of displacement (or bending force or driving force) or an amplitude displacement of a vibration member can be maximized or increased, and thus, a sound characteristic and/or a sound pressure level characteristic of a low pitched sound band can be more enhanced.

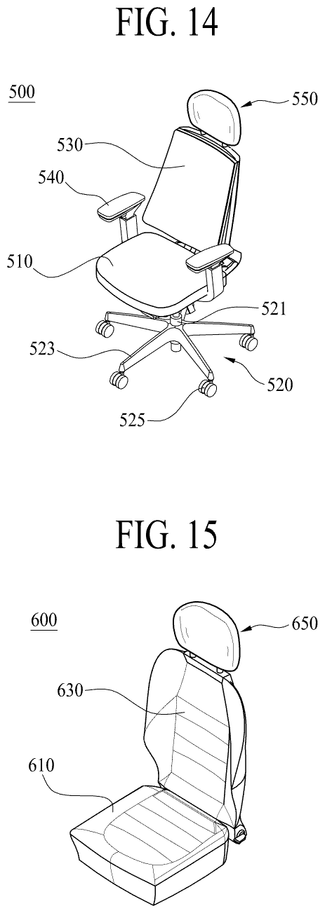

FIG. 14 is a diagram illustrating a chair 500 according to an embodiment of the present disclosure.

Referring to FIG. 14, the chair 500 according to an embodiment of the present disclosure can be a chair for learning, an office chair, or a gaming chair, but embodiments of the present disclosure are not limited thereto.

The chair 500 according to an embodiment of the present disclosure can include a seat part 510, a backrest part 530, and a headrest 550.

The seat part 510 can be configured to enable a user to sit thereon. The seat part 510 can include a seat frame and a cushion seat supported by the seat frame.

The backrest part 530 can be configured to be connected (or coupled) to one side of the seat part 510. For example, the backrest part 530 can include a backrest frame connected (or coupled) to the one side of the seat part 510 and a backrest cushion configured on a front surface of the backrest frame. For example, the backrest part 530 can be configured to rotate (or tilt) with respect to the one side of the seat part 510.

The headrest 550 can be configured to be connected (or coupled) to an upper portion of the backrest part 530.

The backrest part 530 and/or the headrest 550 can be configured to output a sound to a user sitting on the seat part 510. For example, one or more sound apparatuses can be disposed or configured in the backrest part 530 and/or the headrest 550. A sound apparatus applied to the backrest part 530 and/or the headrest 550 according to an embodiment of the present disclosure can be configured to include the sound apparatuses 10, 20, and 30 described above with reference to FIGS. 1 to 13, and thus, its repeated description can be omitted. Also, according to an embodiment, the chair 500 can include one or more of the sound apparatuses 10, 20, and 30 described above.

The chair 500 according to an embodiment of the present disclosure can further include a seat supporting portion 520. The seat supporting portion 520 can include a vertical supporting portion 521 and a plurality of horizontal supporting portions 523.

The vertical supporting portion 521 can be vertically connected (or coupled) to the seat frame of the seat part 510. For example, the vertical supporting portion 521 can be configured to adjust a height of the seat part 510.

The plurality of horizontal supporting portions 523 can be supported to the ground and can be connected (or coupled) to the vertical supporting portion 521 in common. For example, the plurality of horizontal supporting portions 523 can be connected (or coupled) to the vertical supporting portion 521 to have a radial shape with respect to the vertical supporting portion 521, to stably maintain a vertical state of the vertical supporting portion 521.

The seat supporting portion 520 can further include a plurality of roller parts 525. The plurality of roller parts 525 can be respectively connected (or coupled) to the plurality of horizontal supporting portions 523. The plurality of roller parts 525 can rotate based on a movement of the chair 500 with contacting the ground. The movement of the chair 500 can be easily performed by the rotations of the plurality of roller parts 525.

The chair 500 according to an embodiment of the present disclosure can further include a pair of armrest parts 540.

The pair of armrest parts 540 can be configured to support arms of the user sitting on the seat part 510. For example, the pair of armrest parts 540 can be disposed (or configured) at one side (or a left side) and the other side (or a right side) of the seat part 510.

The chair 500 according to an embodiment of the present disclosure can provide a sound to the user sitting on the seat part 510 through the backrest part 530 and/or the headrest 550. For example, the chair 500 can provide an independent sound field or a stereophonic sound to the user sitting on the seat part 510 through the backrest part 530 and/or the headrest 550.

FIG. 15 is a diagram illustrating a vehicular seat 600 according to an embodiment of the present disclosure.

Referring to FIG. 15, the vehicular seat 600 according to an embodiment of the present disclosure can be a driver seat, a front passenger seat, a back seat, or a baby car seat, but embodiments of the present disclosure are not limited thereto.

The vehicular seat 600 according to an embodiment of the present disclosure can include a seat cushion 610, a seat back 630, and a headrest 650.

The seat cushion 610 can be configured so that a passenger of a vehicular apparatus is sit thereon. The seat cushion 610 can include a seat frame and a seat cushion supported by the seat frame.

The seat back 630 can be configured to be connected (or coupled) to one side of the seat cushion 610. For example, the seat back 630 can include a seat back frame connected (or coupled) to the one side of the seat cushion 610 and a seat back cushion configured at a front surface of the seat back frame. For example, the seat back 630 can be configured to rotate (or tilt) with respect to the one side of the seat cushion 610.

The headrest 650 can be configured to be connected to (or supported by) an upper portion of the seat back 630.

The seat back 630 and/or the headrest 650 can be configured to output a sound to a passenger sitting on the seat cushion 610. For example, one or more sound apparatuses can be disposed or configured in the seat back 630 and/or the headrest 650. A sound apparatus applied to the seat back 630 and/or the headrest 650 according to an embodiment of the present disclosure can be configured to include the sound apparatuses 10, 20, and 30 described above with reference to FIGS. 1 to 13, and thus, its repeated description can be omitted. Also, according to an embodiment, the vehicular seat 600 can include one or more of the sound apparatuses 10, 20, and 30 described above.

The vehicular seat 600 according to an embodiment of the present disclosure can provide a sound to the passenger sitting on the seat cushion 610 through the seat back 630 and/or the headrest 650. For example, the vehicular seat 600 can provide an independent sound field or a stereophonic sound to the passenger sitting on the seat cushion 610 through the seat back 630 and/or the headrest 650.

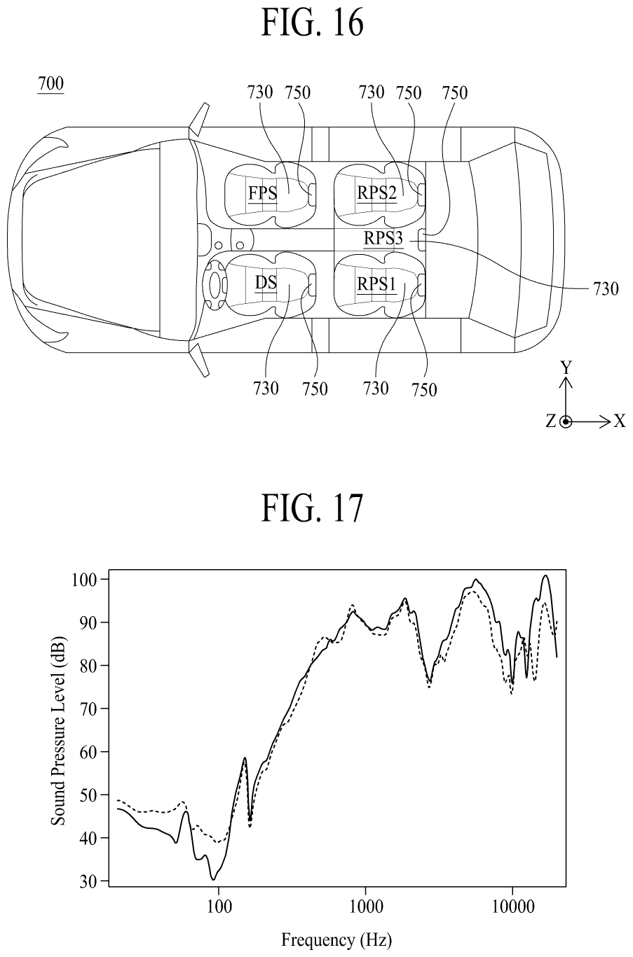

FIG. 16 is a diagram illustrating a vehicular apparatus 700 according to an embodiment of the present disclosure.

Referring to FIG. 16, the vehicular apparatus 700 according to an embodiment of the present disclosure can include a driver seat DS, a front passenger seat FPS, and a plurality of rear passenger seats RPS1 to RPS3.

Each of the driver seat DS and the front passenger seat FPS can be a front seat. Each of the driver seat DS and the front passenger seat FPS can include a seat back 730 and a headrest 750.

One or more sound apparatuses can be disposed or configured in the seat back 730 and/or the headrest 750 of each of the driver seat DS and the front passenger seat FPS according to an embodiment of the present disclosure. A sound apparatus applied to the seat back 730 and/or the headrest 750 according to an embodiment of the present disclosure can be configured to include the sound apparatuses 10, 20, and 30 described above with reference to FIGS. 1 to 13, and thus, its repeated description can be omitted.

The seat back 730 and/or the headrest 750 of the driver seat DS can provide an independent sound field or a stereophonic sound to a driver.

The seat back 730 and/or the headrest 750 of the front passenger seat FPS can provide an independent sound field or a stereophonic sound to a passenger sitting on the front passenger seat FPS.

Each of the plurality of rear passenger seats RPS1 to RPS3 can include a seat back 730 and a headrest 750. The seat back 730 and/or the headrest 750 of each of the plurality of rear passenger seats RPS1 to RPS3 according to an embodiment of the present disclosure can be configured to include the sound apparatuses 10, 20, and 30 described above with reference to FIGS. 1 to 13, and thus, their repeated descriptions can be omitted.

The seat back 730 and/or the headrest 750 of each of the plurality of rear passenger seats RPS1 to RPS3 can provide an independent sound field or a stereophonic sound to a passenger sitting on each of the plurality of rear passenger seats RPS1 to RPS3.

According to another embodiment of the present disclosure, the vehicular apparatus 700 can be configured to include the vehicular seat 600 described above with reference to FIG. 15. For example, one or more of the driver seat DS, the front passenger seat FPS, and the rear passenger seats RPS1 to RPS3 of the vehicular apparatus 700 can be configured to include the vehicular seat 600 described above with reference to FIG. 15, and thus, their repeated descriptions can be omitted.

With reference to FIG. 16, the vehicular apparatus 700 according to an embodiment of the present disclosure can provide an independent sound field or a stereophonic sound to a passenger sitting on a corresponding seat through the seat back 730 and/or the headrest 750 of one or more of the driver seat DS, the front passenger seat FPS, and the plurality of rear passenger seats RPS1 to RPS3. For example, the sound apparatus can provide individual personalized and directional sound with high quality to a specific user, even in situations where space is limited, and the sound quality can be improved in the mid-high frequency range.

FIG. 17 is a diagram illustrating sound output characteristics of sound apparatuses according to an embodiment of the present disclosure and an experiment example.

In FIG. 17, the abscissa axis represents a frequency (Hz), and the ordinate axis represents a sound pressure level (SPL) (dB). A solid line represents a sound output characteristic of the sound apparatus 10 including the guide protrusion portion 400 of FIGS. 1 to 3. A dotted line represents a sound output characteristic of a sound apparatus which does not include a guide protrusion portion.

A sound output characteristic can be measured by a sound analysis apparatus. The sound analysis apparatus can include a sound card which transmits or receives a sound to or from a control personal computer (PC), an amplifier which amplifies a signal generated from the sound card and transfers the amplified signal to a vibration apparatus, and a microphone which collects a sound generated based on driving of the vibration apparatus. The sound collected through the microphone can be input to the control PC through the sound card, and a control program can check the input sound to analyze a sound output characteristic of the vibration apparatus.

A sound output characteristic has been measured in an anechoic chamber which is closed in all directions. A separation distance between the sound apparatus and the microphone has been set to 0.3 m. However, a method of measuring a sound output characteristic is not limited thereto.

Referring to FIG. 17, comparing with the dotted line, in the solid line, it can be seen that a sound pressure level of a middle-high pitched sound band is enhanced.

Comparing with the dotted line, in the solid line, it can be seen that a sound pressure level increases in a pitched sound band of 1 kHz to 10 kHz. For example, comparing with the dotted line, in the solid line, it can be seen that a sound pressure level increases by about 2 dB or more in 3,100 Hz. Comparing with the dotted line, in the solid line, it can be seen that a sound pressure level increases by about 1.5 dB or more in 5,000 Hz. Accordingly, in the sound apparatus according to an embodiment of the present disclosure, a sound characteristic and/or a sound pressure level characteristic of a middle-high pitched sound band of 1 kHz to 10 KHz can be enhanced.

A sound apparatus and a chair, a vehicular seat, and a vehicular apparatus each including the sound apparatus according to one or more embodiments of the present disclosure will be described below. These are provided as examples, and do not limit the scope of the present disclosure.

A sound apparatus according to one or more embodiments of the present disclosure can include an enclosure including an internal space, a vibration member connected to the enclosure and overlapping with the internal space of the enclosure, a vibration device connected to the vibration member and configured to vibrate the vibration member, and a guide protrusion portion protruding from the enclosure and surrounding an edge of the vibration member.

According to one or more embodiments of the present disclosure, the vibration device can include a piezoelectric material.

According to one or more embodiments of the present disclosure, an open space surrounded by the guide protrusion portion can be provided in a front surface of the vibration member.

According to one or more embodiments of the present disclosure, the guide protrusion portion can protrude toward a front surface of the vibration member from an outer surface of the enclosure.

According to one or more embodiments of the present disclosure, the guide protrusion portion can be configured as one body with the enclosure.

According to one or more embodiments of the present disclosure, the guide protrusion portion can include a plurality of guide sidewalls, and the plurality of guide sidewalls can be configured to have a certain height from a front surface of the vibration member.

According to one or more embodiments of the present disclosure, the enclosure can include an inner surface facing the vibration member, and the vibration member can be configured in parallel with the inner surface of the enclosure.

According to one or more embodiments of the present disclosure, the enclosure can include an inner surface facing the vibration member, and the vibration member can be configured to be inclined with respect to the inner surface of the enclosure.

According to one or more embodiments of the present disclosure, the guide protrusion portion can include a plurality of guide sidewalls, and at least two of the plurality of guide sidewalls can be configured to have different heights from a front surface of the vibration member.

According to one or more embodiments of the present disclosure, the plurality of guide sidewalls can include a first guide sidewall, a second guide sidewall facing the first guide sidewall, a third guide sidewall between the first guide sidewall and the second guide sidewall, and a fourth guide sidewall facing the third guide sidewall.

According to one or more embodiments of the present disclosure, the first guide sidewall and the second guide sidewall can have different heights, the third guide sidewall and the fourth guide sidewall can be configured to each include a slope surface based on a height difference between the first guide sidewall and the second guide sidewall.

According to one or more embodiments of the present disclosure, an incline of the vibration member can correspond to the slope surface.

According to one or more embodiments of the present disclosure, the enclosure can include a bottom portion including an inner surface facing the vibration member, and a supporting portion protruding vertically from an edge of the bottom portion and supporting the edge of the vibration member.

According to one or more embodiments of the present disclosure, the guide protrusion portion can protrude toward a front surface of the vibration member from an outer surface of the supporting portion to surround the edge of the vibration member.

According to one or more embodiments of the present disclosure, the supporting portion can have a certain height from the inner surface of the bottom portion.

According to one or more embodiments of the present disclosure, the supporting portion can have different heights from the inner surface of the bottom portion.

According to one or more embodiments of the present disclosure, the sound apparatus can further include a coupling member between the supporting portion and the vibration member.

According to one or more embodiments of the present disclosure, the vibration member can include one or more materials of metal, wood, rubber, plastic, carbon, glass, fiber, cloth, paper, mirror, and leather.

According to one or more embodiments of the present disclosure, the vibration device can include a vibration part including a piezoelectric material, a cover member at one or more of a first surface of the vibration portion and a second surface opposite to the first surface, of the vibration portion, and a signal supply member electrically connected to the vibration portion.

According to one or more embodiments of the present disclosure, a portion of the signal supply member can be between the cover member and the vibration part.

A chair according to one or more embodiments of the present disclosure can include a seat part, a backrest part connected to the seat part, and at least one sound generating apparatus disposed on the backrest part and configured to output a sound toward a front surface of the backrest part. The at least one sound generating apparatus can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

A vehicular seat according to one or more embodiments of the present disclosure can include a seat cushion, a seat back connected to the seat cushion, and at least one sound generating apparatus disposed on the seat back and configured to output a sound toward a front surface of the seat back. The at least one sound generating apparatus can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

A vehicular apparatus according to one or more embodiments of the present disclosure can include the vehicular seat. The vehicular seat can include a seat cushion, a seat back connected to the seat cushion, and at least one sound generating apparatus disposed on the seat back and configured to output a sound toward a front surface of the seat back. The at least one sound generating apparatus can include an enclosure including an internal space, a vibration member connected to the enclosure and configured to cover the internal space of the enclosure, a vibration device connected to the vibration member and configured to vibrate the vibration member, and a guide protrusion portion protruding from the enclosure to surround an edge of the vibration member.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A sound apparatus comprising:
an enclosure including an internal space;
a vibration member connected to the enclosure and overlapping with the internal space of the enclosure;
a vibration device connected to the vibration member and configured to vibrate the vibration member; and
a guide protrusion portion protruding from the enclosure and surrounding an edge of the vibration member.

2. The sound apparatus of claim 1, wherein an open space surrounded by the guide protrusion portion is provided in a front surface of the vibration member.

3. The sound apparatus of claim 1, wherein the guide protrusion portion protrudes toward a front surface of the vibration member from an outer surface of the enclosure, and is configured as one body with the enclosure.

4. The sound apparatus of claim 1, wherein the guide protrusion portion includes a plurality of guide sidewalls, and
wherein the plurality of guide sidewalls have a certain height from a front surface of the vibration member.

5. The sound apparatus of claim 1, wherein the enclosure includes an inner surface facing the vibration member, and
wherein the vibration member is parallel with the inner surface of the enclosure or inclined with respect to the inner surface of the enclosure.

6. The sound apparatus of claim 1, wherein the guide protrusion portion comprises includes a plurality of guide sidewalls, and
wherein at least two of the plurality of guide sidewalls are configured to have different heights from a front surface of the vibration member.

7. The sound apparatus of claim 6, wherein the plurality of guide sidewalls include:
a first guide sidewall;
a second guide sidewall facing the first guide sidewall;
a third guide sidewall between the first guide sidewall and the second guide sidewall; and
a fourth guide sidewall facing the third guide sidewall.

8. The sound apparatus of claim 7, wherein the first guide sidewall and the second guide sidewall have different heights, and
wherein the third guide sidewall and the fourth guide sidewall each include a slope surface based on a height difference between the first guide sidewall and the second guide sidewall.

9. The sound apparatus of claim 8, wherein an incline of the vibration member corresponds to the slope surface.

10. The sound apparatus of claim 1, wherein the enclosure includes:
a bottom portion including an inner surface facing the vibration member; and
a supporting portion protruding from an edge of the bottom portion and supporting the edge of the vibration member.

11. The sound apparatus of claim 10, wherein the guide protrusion portion protrudes toward a front surface of the vibration member from an outer surface of the supporting portion to surround the edge of the vibration member.

12. The sound apparatus of claim 10, wherein the supporting portion has a certain height from the inner surface of the bottom portion.

13. The sound apparatus of claim 10, wherein portions of the supporting portion have different heights from the inner surface of the bottom portion.

14. The sound apparatus of claim 10, further comprising a coupling member between the supporting portion and the vibration member.

15. The sound apparatus of claim 1, wherein the vibration member includes one or more materials of metal, wood, rubber, plastic, carbon, glass, fiber, cloth, paper, mirror, and leather.

16. The sound apparatus of claim 1, wherein the vibration device includes:
a vibration part including a piezoelectric material;
a cover member at one or more of a first surface of the vibration portion and a second surface opposite to the first surface of the vibration portion; and
a signal supply member electrically connected to the vibration portion.

17. The sound apparatus of claim 16, wherein a portion of the signal supply member is between the cover member and the vibration part.

18. A chair comprising:
a seat part;
a backrest part connected to the seat part; and
at least one sound generating apparatus disposed on the backrest part and configured to output a sound toward a front surface of the backrest part,
wherein the at least one sound generating apparatus includes the sound apparatus of claim 1.

19. A vehicular seat comprising:
a seat cushion;
a seat back connected to the seat cushion; and
at least one sound generating apparatus disposed on the seat back and configured to output a sound toward a front surface of the seat back,
wherein the at least one sound generating apparatus includes the sound apparatus of claim 1.

20. A vehicular apparatus comprising the vehicular seat of claim 19.
